(19) United States
(12) Patent Application Publication
(10) Pub. No.: US 2023/0176926 A1
(43) Pub. Date: Jun. 8, 2023

(54) VIRTUAL RESOURCE MANAGEMENT DEVICE, VIRTUAL RESOURCE MANAGEMENT METHOD AND PROGRAM

(71) Applicant: Nippon Telegraph and Telephone Corporation, Tokyo (JP)

(72) Inventors: Hiroyuki JO, Musashino-shi, Tokyo (JP); Keiko KURIU, Musashino-shi, Tokyo (JP)

(21) Appl. No.: 17/919,918

(22) PCT Filed: May 18, 2020
(86) PCT No.: PCT/JP2020/019670

§ 371 Date: Oct. 19, 2022

(51) Int. Cl. G06F 9/50

(52) U.S. Cl. CPC G06F 9/5077; G06F 2209/503; G06F 2209/5014

(57) ABSTRACT

A virtual resource management device (1) includes a scaling request reception unit (11) that receives a scale-in request; a virtual resource identification unit (12) that identifies a virtual resource to be deleted by using a predetermined virtual resource identification logic according to a deletion strategy indicated by the scale-in request; and a scaling processing unit (13) that transmits a scale-in preparation request including information on the identified virtual resource to the VNF to stop communication to the virtual resource, and in response to receiving a scale-in preparation completion response indicating the communication has been stopped from the VNF, deletes the virtual resource to be deleted.

### TECHNICAL FIELD

The present invention relates to a virtual resource management device, a virtual resource management method, and a program for managing virtual resources of a virtualized network.

### BACKGROUND ART

In recent years, for carrier networks, virtualization and cloud-based, that is, NFV (Network Functions Virtualization) has been trending. In an NFV network system, a resource management system manages the resources provided by physical devices as virtual resources to, for example, reserve, allocate, and recover the resources according to a user's request (e.g., see PTL 1 and PTL 2).

According to the ETSI (European Telecommunications Standards Institute) NFV standards specifications (see NPL 1), a virtualized network function implemented in an NFV network system is called a VNF (Virtual Network Function), and a function that manages the life cycle of the VNF is called a VNFM (VNF Manager).

The VNFM provides an interface for VNF lifecycle management. For example, there are interfaces for VNF creation, deletion, scaling, etc. The VNF creation is to perform appropriate initialization processing in response to a required amount of virtual resources being allocated by the resource management system. Various network functions and services are performed on such a created VNF. The VNF deletion is to perform appropriate termination processing to release the virtual resources. The VNF scaling is to increase or reduce the amount of virtual resources that make up the VNF. The processing of increasing virtual resources is called scale-out, and the processing of reducing the virtual resources is called scale-in.

Use cases for the scaling include the followings.
[Use case 1]: the processing performance of the VNF is increased or reduced according to an increase or decrease in demand.
[Use case 2]: Before maintenance, replacement, or disposal of a specific physical device, the virtual resources operating on that physical device are released by scale-in.
[Use case 3]: At the time of VNF creation, some virtual resources are using reserved resources for which a period of use is specified, and the corresponding virtual resources are released by scale-in before the end of the period of use.

### CITATION LIST

### Patent Literature

[PTL 1] Japanese Patent Application Publication No. 2017-143452

[PTL 2] Japanese Patent Application Publication No. 2018-196036

### Non Patent Literature

[NPL 1] “ETSI GS NFV-SOL 002 V2.6.1”, [online], ETSI, 2019-04, [Retrieved on Apr. 27, 2020], Internet <URL: https://www.etsi.org/deliver/etsi_gs/NFV-SOL/001_099/002/02.06.01 60/gs NFV-SOL002v020601p.pdf>

### SUMMARY OF THE INVENTION

### Technical Problem

The ETSI NFV standards specifications (NPL 1) define an interface for VNF scaling, but does not define a specific processing method for the interface. Further, for the scaling interface, parameters defined as the request parameters for a scaling request are illustrated in FIG. 12.

As illustrated in FIG. 12, “type”, “aspectId”, “numberOfSteps”, and “additionalParams” are defined as the parameters for the VNF scaling request. The parameter “type” specifies scale-out or scale-in. The parameter “aspectId” specifies a component in the VNF to be scaled. The parameter “numberOfSteps” specifies the number of steps of scale-out or scale-in. The parameter “additionalParams” specifies other parameters that can be optionally added as needed.

The above [Use case 1] aims at only increasing or reducing the performance of the VNF, so that the virtual resources can be released without identifying a specific virtual resource in scale-in, and the defined parameters are also sufficient.

On the other hand, [Use case 2] and [Use case 3] needs to release a specific virtual resource in scale-in. Accordingly, the VNFM needs to specify such a virtual resource, and requires additional parameters for responding to a scale-in request.

The present invention has been made in view of the foregoing, and an object of the present invention is to identify and release a virtual resource when scale-in is performed that is processing of reducing the amount of virtual resources that make up a VNF.

### Means for Solving the Problem

A virtual resource management device according to the present invention executes scale-in of virtual resources that make up a VNF. The virtual resource management device includes a scaling request reception unit that receives a scale-in request that is a scaling request to request scale-in; a virtual resource identification unit that identifies a virtual resource to be deleted by using a predetermined virtual resource identification logic according to a deletion strategy indicated by the scale-in request; and a scaling processing unit that transmits a scale-in preparation request including information on the identified virtual resource to the VNF to which the virtual resource to be deleted is assigned to stop communication to the virtual resource to be deleted, and in response to receiving a scale-in preparation completion response indicating the communication has been stopped from the VNF, deletes the virtual resource to be deleted.

### Effects of the Invention

According to the present invention, it is possible to identify and release a virtual resource when scale-in is performed that is processing of reducing the amount of virtual resources that make up a VNF.

### BRIEF DESCRIPTION OF DRAWINGS

FIG. 1 is a diagram illustrating the whole configuration of a network virtualization system including a virtual resource management device according to an embodiment.

FIG. 2 illustrates parameters for a VNF scaling request according to the present embodiment.

FIG. 3 illustrates an example in which a deletion strategy for “deletion target specification” which is a parameter for a scaling request according to the present embodiment is described in JSON format.

FIG. 4 illustrates an example in which a deletion strategy for “deletion target specification” which is a parameter for a scaling request according to the present embodiment is described in JSON format.

FIG. 5 illustrates an example in which a deletion strategy for “maintenance save” which is a parameter for a scaling request according to the present embodiment is described in JSON format.

FIG. 6 illustrates an example in which a deletion strategy for “maintenance save” which is a parameter for a scaling request according to the present embodiment is described in JSON format.

FIG. 7 illustrates an example in which a deletion strategy for “reserved resource release” which is a parameter for a scaling request according to the present embodiment is described in JSON format.

FIG. 8 illustrates an example in which a deletion strategy for “reserved resource release” which is a parameter for a scaling request according to the present embodiment is described in JSON format.

FIG. 9 is a flowchart illustrating a flow of processing of scaling in a specific virtual resource in the network virtualization system according to the present embodiment.

FIG. 10 is a functional block diagram illustrating the configuration of a virtual resource management device according to a modification of the present embodiment.

FIG. 11 is a hardware configuration diagram illustrating an example of a computer that implements the functions of the virtual resource management device according to the present embodiment.

FIG. 12 illustrates parameters for a VNF scaling request according to a conventional technique.

### DESCRIPTION OF EMBODIMENTS

An embodiment for carrying out the present invention (hereinafter, referred to as “the present embodiment”) will be described below.

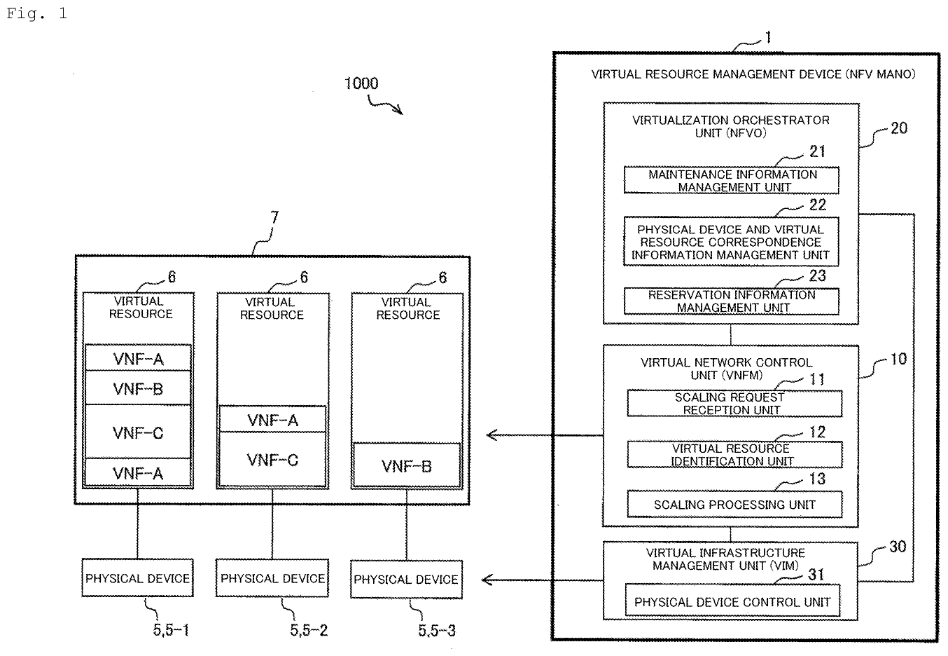

FIG. 1 is a diagram illustrating the whole configuration of a network virtualization system 1000 including a virtual resource management device 1 according to an embodiment.

The network virtualization system 1000 includes one or more VNFs; a plurality of physical devices 5 (physical devices 5-1, 5-2, and 5-3 as an example in FIG. 1) and a virtual infrastructure 7 built on the plurality of physical devices 5, which are an infrastructure for implementing the functions of the VNFs; and the virtual resource management device 1 that manages virtual resources for implementing a virtual network.

The VNF implements a virtualized network function by using the virtual infrastructure 7 provided on the plurality of physical devices 5 (5-1, 5-2, 5-3). This VNF is composed of one or more virtual machines (VMs) that implement virtualized functions by a virtual resource 6 being allocated. In FIG. 1, for example, VNF-A is implemented using three virtual resources in total, two VMs using the virtual resource 6 on the physical device 5-1 and one VM using the virtual resource 6 on the physical device 5-2. VNF-B is implemented using two virtual resources in total, one VM using the virtual resource 6 on the physical device 5-1 and one VM using the virtual resource 6 on the physical device 5-3. VNF-C is implemented using two virtual resources in total, one VM using the virtual resource 6 on the physical device 5-1 and one VM using the virtual resource 6 on the physical device 5-2.

The physical device 5 is a physical hardware resource such as a computer, a storage, and a network device. Such a physical hardware resource is virtualized with software called a virtualization layer to build the virtual infrastructure 7, thereby providing the VNF with the virtual resource 6 such as a virtual computer, a virtual storage, and a virtual network.

The virtual resource management device 1 is a device that controls scale-in, which is processing of reducing virtual resources that make up a VNF. This virtual resource management device 1 is characterized in that a desired virtual resource is identified and deleted (released) when the scale-in of virtual resources is controlled.

Note that this virtual resource management device 1 can be realized in which functions corresponding to the features in the present application are incorporated, in NFV MANO (NFV Management and Orchestration) in the ETSI NFV standards specifications (NPL 1). Accordingly, a feature configuration in the present application will be described below in association with a VNFM, an NFVO (NFV Orchestrator), and a VIM (Virtualized Infrastructure Manager), which are three functions the NFV MANO has. Note that a detailed description of the standard functions the NFV MANO has will be omitted.

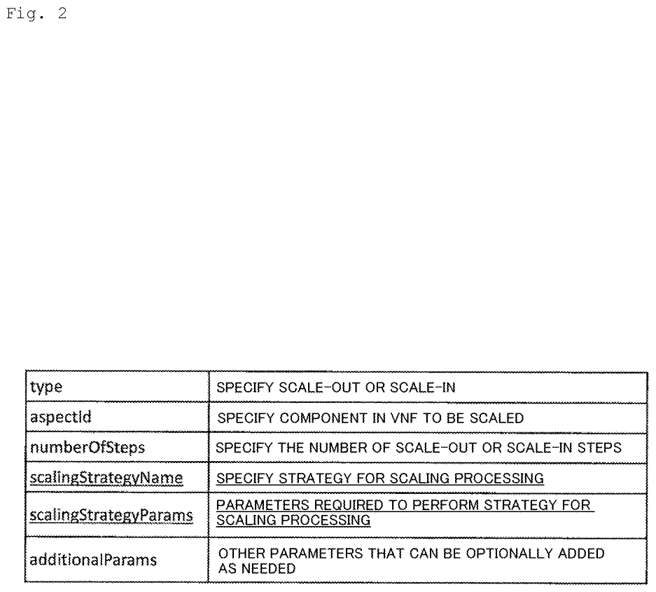

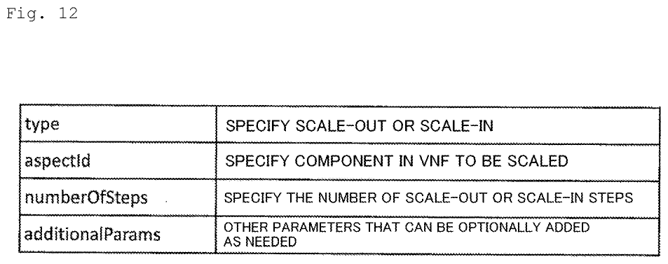

Further, in the network virtualization system 1000 according to the present embodiment, the virtual resource management device 1 adds, to the request parameters for the conventional scaling request illustrated in FIG. 12, a parameter for specifying a “deletion strategy” (hereinafter referred to as “scaling strategy name”) and information necessary for executing scaling according to the deletion strategy (hereinafter referred to as “scaling additional parameters”) (see FIG. 2), in order to identify a virtual resource to be deleted.

Specifically, as illustrated in FIG. 2, parameters “scalingStrategyName” and “scalingStrategyParams” are added to the parameters for the VNF scaling request.

The parameter “scalingStrategyName” is for specifying a deletion strategy for scaling processing. In the present embodiment, “deletion target specification”, “maintenance save”, and “reserved resource release” are selectable as examples of the deletion strategy (details of which will be described later).

As “scalingStrategyParams” (additional scaling parameters), the parameters required to execute the deletion strategy for the scaling processing are specified.

In response to receiving a scaling request including “scalingStrategyName” and “scalingStrategyParams”, the virtual resource management device 1 executes scale-in in which a virtual resource is identified and deleted.

### Virtual Resource Management Device

Next, the virtual resource management device 1 according to the present embodiment will be described in detail with reference to FIG. 1.

The virtual resource management device 1 controls processing (scale-in) of identifying a virtual resource to reduce virtual resources that make up a VNF, in addition to the functions of the NFV MANO that comprehensively manages and controls the virtual network and resources.

This virtual resource management device 1 includes a general computer including a control unit, an input/output unit, and a storage unit (which are all not illustrated) (details of which will be described later).

The input/output unit receives an input of information and outputs information to each VNF, the physical device 5, other external devices, and the like. This input/output unit includes a communication interface for transmitting and receiving information via a communication line, and an input/output interface for receiving an input of information from an input device such as a keyboard (not illustrated) and outputting information to an output device such as a monitor (not illustrated).

The storage unit includes a hard disk, a flash memory, a RAM (Random Access Memory), and the like. This storage unit stores information necessary for processing according to the present embodiment, such as maintenance information, physical device and virtual resource correspondence information, and reservation information (all of which will be described later in detail).

Further, the storage unit temporarily stores a program for implementing each functional unit of the control unit and information necessary for processing of the control unit.

As illustrated in FIG. 1, the control unit includes a virtual network control unit 10, a virtualization orchestrator unit 20, and a virtual infrastructure management unit 30.

The virtual network control unit 10 includes a scaling request reception unit 11, a virtual resource identification unit 12, and a scaling processing unit 13, which are functions specific to the present embodiment, in addition to the functions of the VNFM to manage the resource requirements required by the VNF and the life cycle of the VNF, specified by the ETSI NFV standards specifications.

The scaling request reception unit 11 receives a scaling request from a client terminal or the like. Then, the scaling request reception unit 11 checks whether or not the scaling request specifies the scale-in, and parameters for specifying a deletion strategy as described above and scaling additional parameters are set therein. Specifically, the scaling request reception unit 11 checks whether the received scaling request is a message to request scale-in to delete (release) a specific virtual resource (hereinafter, referred to as “scale-in request”).

For the deletion strategy specified in the scale-in request, the above-mentioned “deletion target specification”, “maintenance save”, and “reserved resource release” are selectable. Hereinafter, each deletion strategy will be specifically described.

### Delete Strategy 1 For “Deletion Target Specification”

The “deletion target specification” is a deletion strategy for deleting the specified virtual resource in the scale-in request (message). In the deletion strategy for “deletion target specification”, for example, “resource” is specified as the scaling strategy name. In addition, a virtual resource ID of the virtual resource to be deleted is specified as a scaling additional parameter. The virtual resource ID is an ID for uniquely identifying the created virtual resource, and is assigned when the virtual resource is created.

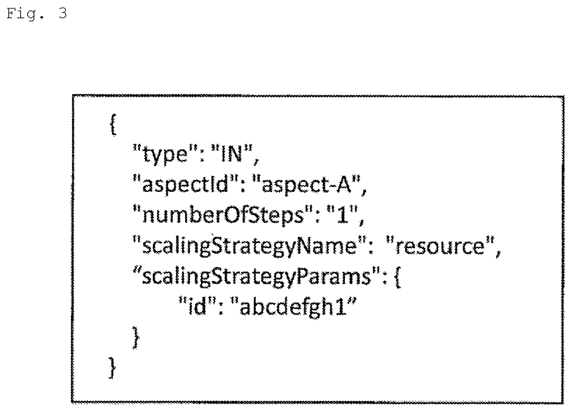

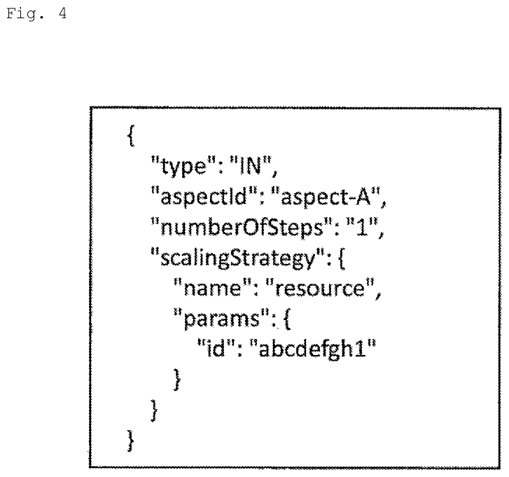

FIGS. 3 and 4 are examples in which the deletion strategy for “deletion target specification” is described in JSON (JavaScript Object Notation) format.

In FIGS. 3 and 4, “resource” is specified as the parameter “scalingStrategyName”. Further, they illustrate examples in which the virtual resource ID “abcdefgh1” is described as the parameter “scalingStrategyParams”. Note that the structure of the request parameters is not limited to the two parameters.

### Delete Strategy 2 For “Maintenance Save”

The “maintenance save” is a deletion strategy for identifying a virtual resource included in the VNF being operated on a specific physical device 5 to be maintained such as replacement or disposal, and deleting the virtual resource in the scale-in request (message). In the deletion strategy for “maintenance save”, for example, “maintenance” is specified as the scaling strategy name. In addition, a maintenance ID is specified as a scaling additional parameter. The maintenance ID is an ID for uniquely identifying information on maintenance such as replacement or disposal of the specific physical device 5. This maintenance information is registered in the NFV system by an operator before the maintenance is performed. For example, it is registered in the virtualization orchestrator unit 20 (NFVO) of the virtual resource management device 1 (details of which will be described later).

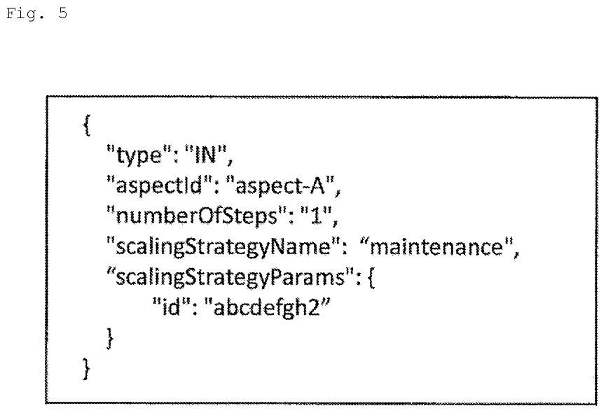

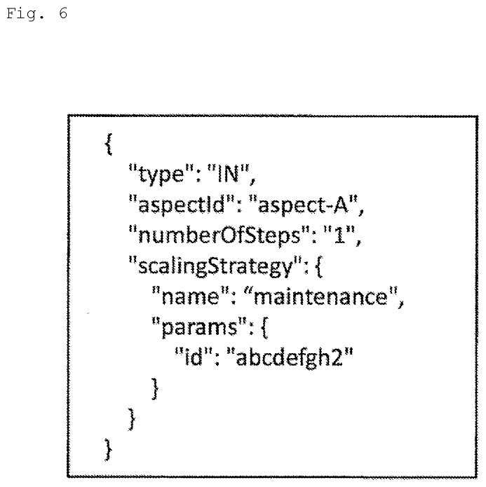

FIGS. 5 and 6 are examples in which the deletion strategy for “maintenance save” is described in JSON format.

In FIGS. 5 and 6, “maintenance” is specified as the parameter “scalingStrategyName”. Further, they illustrate examples in which the maintenance ID “abcdefgh2” is described as the parameter “scalingStrategyParams”. Note that the structure of the request parameters is not limited to the two parameters.

### Delete Strategy 3 For “Reserved Resource Release”

The “reserved resource release” is a deletion strategy for identifying and deleting a virtual resource being operated corresponding to a reserved resource in the scale-in request (message). In the deletion strategy for “reserved resource release”, for example, “reservation” is specified as the scaling strategy name. In addition, a reservation ID is specified as a scaling additional parameter. The reservation ID is an ID for uniquely identifying information on the reservation of a virtual resource. This reservation information is registered in the NFV system by a user before the user uses the virtual resource. For example, it is registered in the virtualization orchestrator unit 20 (NFVO) of the virtual resource management device 1 (details of which will be described later).

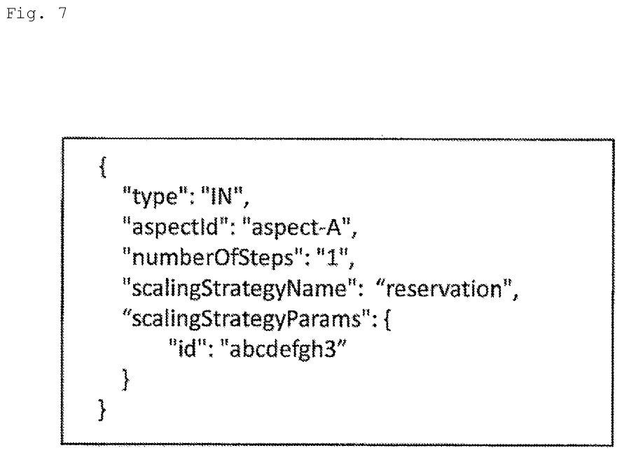

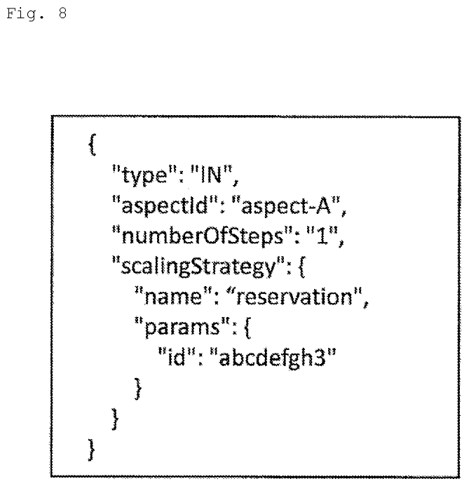

FIGS. 7 and 8 are examples in which the deletion strategy for “reserved resource release” is described in JSON format.

In FIGS. 7 and 8, “reservation” is specified as the parameter “scalingStrategyName”. Further, they illustrate examples in which the reservation ID “abcdefgh3” is described as the parameter “scalingStrategyParams”. Note that the structure of the request parameters is not limited to the two parameters.

When the deletion strategy for requesting the deletion (release) of a specific virtual resource is specified in the received scaling request as described above, the scaling request reception unit 11 determines that the scaling request is a “scale-in request”. Then, the scaling request reception unit 11 outputs the information on the scale-in request to the virtual resource identification unit 12.

In response to receiving the scaling request (message), the virtual resource identification unit 12 checks the deletion strategy indicated by the scale-in request and then identifies a virtual resource to be deleted.

The virtual resource identification unit 12 follows a predetermined logic (virtual resource identification logic) according to the selected deletion strategy (“deletion target specification”, “maintenance save”, or “reserved resource release” in this example) to identify the virtual resource to be deleted.

### Virtual Resource Identification Logic For “Deletion Target Specification”

For the deletion strategy for “deletion target specification”, that is, for the scaling strategy name (“scalingStrategyName”) parameter of “resource” specified in the scaling request, the virtual resource identification unit 12 identifies a virtual resource based on the following virtual resource identification logic.

For the deletion strategy for “deletion target specification”, the virtual resource identification unit 12 identifies a virtual resource to be deleted based on the virtual resource ID specified as a scaling additional parameter.

Specifically, the virtual resource identification unit 12 identifies, as the virtual resource to be deleted, the virtual resource indicated by the virtual resource ID specified as a scaling additional parameter (“scalingStrategyParams”) in the scaling request.

### Virtual Resource Identification Logic For “Maintenance Save”

For the deletion strategy for “maintenance save”, that is, for the scaling strategy name (“scalingStrategyName”) parameter of “maintenance” specified in the scaling request, the virtual resource identification unit 12 identifies a virtual resource based on the following virtual resource identification logic.

For the deletion strategy for “maintenance save”, the virtual resource identification unit 12 extracts the maintenance ID specified as a scaling additional parameter (“scalingStrategyParams”). Then, the virtual resource identification unit 12 identifies a physical device 5 to be maintained by referring to the maintenance information based on the extracted maintenance ID. Further, the virtual resource identification unit 12 refers to the physical device and virtual resource correspondence information by using the information on the identified physical device 5, and identifies a virtual resource being operated on the physical device 5 to be maintained.

Here, the maintenance information is stored in a storage unit (not illustrated) of the virtual resource management device 1 and is information for associating the maintenance ID with the physical device 5 to be maintained. It is here assumed that this maintenance information is managed (controlled) by a maintenance information management unit 21 of the virtualization orchestrator unit 20 (NFVO) illustrated in FIG. 1. However, the virtual network control unit 10 (VNFM) may be configured to have a function for managing (controlling) this maintenance information, or an external device other than the virtual resource management device 1 may be configured to have the maintenance information and a function for managing the maintenance information.

Further, the physical device and virtual resource correspondence information is stored in a storage unit (not illustrated) of the virtual resource management device 1 and is information in which the physical device 5 and the virtual resource being operated on the physical device 5 are associated with each other. It is here assumed that a physical device and virtual resource correspondence information management unit 22 of the virtualization orchestrator unit 20 (NFVO) illustrated in FIG. 1 manages (controls) this physical device and virtual resource correspondence information. However, the virtual network control unit 10 (VNFM) may be configured to have a function for managing (controlling) this physical device and virtual resource correspondence information, or an external device other than the virtual resource management device 1 may be configured to have the physical device and virtual resource correspondence information and a function for managing the physical device and virtual resource correspondence information.

For example, in a case where the virtualization orchestrator unit 20 is configured to manage (control) the maintenance information and the physical device and virtual resource correspondence information, the virtual resource identification unit 12 outputs the maintenance ID extracted from the scale-in request to the virtualization orchestrator unit 20. In response to this, the maintenance information management unit 21 of the virtualization orchestrator unit 20 refers to the maintenance information, and extracts the physical device 5 corresponding to the maintenance ID. Then, the physical device and virtual resource correspondence information management unit 22 extracts the virtual resource(s) being operated on the physical device 5 with reference to the physical device and virtual resource correspondence information. The virtual resource identification unit 12 acquires the information on the extracted virtual resource(s) from the physical device and virtual resource correspondence information management unit 22, thereby identifying the virtual resource(s) to be deleted.

### Virtual Resource Identification Logic For “Reserved Resource Release”

For the deletion strategy for “reserved resource release”, that is, for the scaling strategy name (“scalingStrategyName”) parameter of “reservation” specified in the scaling request, the virtual resource identification unit 12 identifies a virtual resource based on the following virtual resource identification logic.

For the deletion strategy for “reserved resource release”, the virtual resource identification unit 12 extracts the reservation ID specified as a scaling additional parameter (“scalingStrategyParams”). Then, the virtual resource identification unit 12 identifies a target reservation by referring to the reservation information based on the extracted reservation ID. The virtual resource identification unit 12 identifies a virtual resource being operated corresponding the reserved resource.

Here, the reservation information is stored in the storage unit (not illustrated) of the virtual resource management device 1 and is information in which the reservation ID and the virtual resource being operated corresponding the reserved resource are associated with each other. It is here assumed that this reservation information is managed (controlled) by a reservation information management unit 23 of the virtualization orchestrator unit 20 (NFVO) illustrated in FIG. 1. However, the virtual network control unit 10 (VNFM) may be configured to have a function for managing (controlling) this reservation information, or an external device other than the virtual resource management device 1 may be configured to have the reservation information and a function for managing the reservation information.

For example, in a case where the virtualization orchestrator unit 20 is configured to manage (control) the reservation information, the virtual resource identification unit 12 outputs the reservation ID extracted from the scale-in request to the virtualization orchestrator unit 20. In response to this, the reservation information management unit 23 of the virtualization orchestrator unit 20 extracts the information on the virtual resource being operated by the reserved resource(s) from the reservation information corresponding to the reservation ID. The virtual resource identification unit 12 acquires the information on the extracted virtual resource(s) from the reservation information management unit 23, thereby identifying the virtual resource(s) to be deleted.

When the virtual resource identification unit 12 identifies the virtual resource to be deleted by the processing based on the above-described virtual resource identification logic, the virtual resource identification unit 12 outputs the information on that virtual resource to the scaling processing unit 13.

The scaling processing unit 13 transmits a scale-in preparation request, including the virtual resource ID of the virtual resource to be deleted identified by the virtual resource identification unit 12, to a corresponding VNF. Note that the corresponding VNF can be identified by “aspectID” which is a parameter indicated by the scaling request (e.g., see FIGS. 3 to 8) received by the scaling request reception unit 11.

In response to receiving this scale-in preparation request, the VNF prepares for scale-in. The preparation for scale-in is, for example, stopping the communication to the virtual resource to be deleted among the communications, transmitted from a client and other VNFs, which are processed by that VNF.

The scaling processing unit 13 receives a scale-in preparation completion response from the VNF that has completed the scale-in preparation. Then, as a result of receiving the scaling preparation completion response, the scaling processing unit 13 deletes the virtual resource to be deleted.

Next, the virtualization orchestrator unit 20 includes the maintenance information management unit 21, the physical device and virtual resource correspondence information management unit 22, and the reservation information management unit 23, which are functions specific to the present embodiment, in addition to the functions of the NFVO to manage (create, manage, operate, delete, etc.) the life cycle of a network service that makes up a plurality of VNFs and to manage all the resources, specified by the ETSI NFV standards specifications.

When the maintenance information management unit 21 acquires the maintenance ID from the virtual network control unit 10 (virtual resource identification unit 12), the maintenance information management unit 21 refers to the maintenance information stored in the storage unit and extracts the physical device 5 corresponding to the maintenance ID.

Then, the maintenance information management unit 21 outputs the extracted information on the physical device 5 to the physical device and virtual resource correspondence information management unit 22.

Further, the maintenance information management unit 21 acquires new maintenance information regarding the physical device 5 from an external device or the like and registers the new maintenance information in the maintenance information stored in the storage unit.

When the physical device and virtual resource correspondence information management unit 22 acquires the information on the physical device 5 from the maintenance information management unit 21, the physical device and virtual resource correspondence information management unit 22 refers to the physical device and virtual resource correspondence information stored in the storage unit and extracts the virtual resource(s) being operated on the physical device 5.

Then, the physical device and virtual resource correspondence information management unit 22 outputs the extracted virtual resource information to the virtual network control unit 10 (virtual resource identification unit 12).

Further, the physical device and virtual resource correspondence information management unit 22 acquires the latest information regarding the configuration of the virtual resource being operated on the physical device 5 and registers the latest information in the physical device and virtual resource correspondence information stored in the storage unit.

When the reservation information management unit 23 acquires the reservation ID from the virtual network control unit 10 (virtual resource identification unit 12), the reservation information management unit 23 refers to the reservation information stored in the storage unit and extracts information on the virtual resource being operated corresponding to the reserved resource from the reservation information indicated by the reservation ID.

Then, the reservation information management unit 23 outputs the extracted virtual resource information to the virtual network control unit 10 (virtual resource identification unit 12).

Further, the reservation information management unit 23 acquires new reservation information regarding resource reservation from a client terminal or the like and registers the new reservation information in the reservation information stored in the storage unit.

Here, the virtual infrastructure management unit 30 has the functions of the VIM to manage the operation and management of the physical resources and virtual resources, specified by the ETSI NFV standards specifications. A physical device control unit 31 included in the virtual infrastructure management unit 30 manages and controls each physical device 5 to perform maintenance such as replacement or disposal of the physical device 5.

### Processing Flow

Next, a processing flow of the network virtualization system 1000 including the virtual resource management device 1 according to the present embodiment will be described.

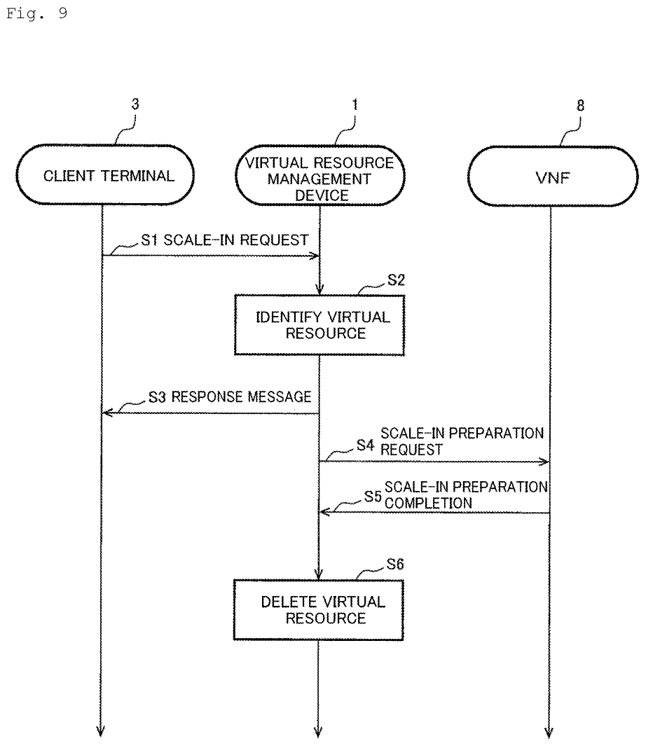

FIG. 9 is a flowchart illustrating a flow of scale-in processing of deleting (releasing) a specific virtual resource in the network virtualization system 1000 according to the present embodiment.

Here, as illustrated in FIG. 9, a case will be described in which a scaling request (scale-in request) to specify scale-in is received from a client terminal 3.

First, the virtual resource management device 1 receives a scale-in request from the client terminal 3 (step S1).

Then, the scaling request reception unit 11 of the virtual resource management device 1 (virtual network control unit 10) checks whether or not the scaling request specifies the scale-in, and parameters for specifying a deletion strategy and scaling additional parameters are set therein. Specifically, the scaling request reception unit 11 checks whether the received scaling request is a message to request scale-in to delete (release) a specific virtual resource (scale-in request). When the received scaling request is a scale-in request, the scaling request reception unit 11 outputs the scale-in request to the virtual resource identification unit 12.

The virtual resource identification unit 12 of the virtual resource management device 1 (virtual network control unit 10) checks the deletion strategy indicated by the scale-in request and then follows a predetermined logic (virtual resource identification logic) according to the deletion strategy to identify a virtual resource to be deleted (step S2).

Here, for the deletion strategy for “deletion target specification”, that is, for the scaling strategy name (“scalingStrategyName”) parameter of “resource” specified in the scaling request as illustrated in FIGS. 3 and 4, the virtual resource identification unit 12 identifies the virtual resource to be deleted based on the virtual resource ID specified as the scaling additional parameter (“scalingStrategyParams”).

Further, for the deletion strategy for “maintenance save”, that is, for the scaling strategy name (“scalingStrategyName”) parameter of “maintenance” specified in the scaling request, the virtual resource identification unit 12 extracts the maintenance ID specified as the scaling additional parameter (“scalingStrategyParams”). Then, the virtual resource identification unit 12 identifies a physical device 5 to be maintained by referring to the maintenance information based on the extracted maintenance ID. Further, the virtual resource identification unit 12 refers to the physical device and virtual resource correspondence information by using the information on the identified physical device 5, and identifies a virtual resource being operated on the physical device 5 to be maintained.

Note that, when the virtual resource identification unit 12 cannot refer to the maintenance information and the physical device and virtual resource correspondence information by itself, the virtual resource identification unit 12 inquires of the virtualization orchestrator unit 20 or an external device, which has a function of managing (controlling) the maintenance information and the physical device and virtual resource correspondence information, thereby identifying a virtual resource to be deleted.

Further, for the deletion strategy for “reserved resource release”, that is, for the scaling strategy name (“scalingStrategyName”) parameter of “reservation” specified in the scaling request, the virtual resource identification unit 12 extracts the reservation ID specified as the scaling additional parameter (“scalingStrategyParams”). Then, the virtual resource identification unit 12 identifies a target reservation by referring to the reservation information based on the extracted reservation ID, and identifies a virtual resource being operated corresponding to the reserved resource.

Note that, when the virtual resource identification unit 12 cannot refer to the reservation information by itself, the virtual resource identification unit 12 inquires of the virtualization orchestrator unit 20 or an external device, which has a function of managing (controlling) the reservation information, thereby identifying a virtual resource to be deleted.

Next, the scaling request reception unit transmits to the client terminal 3 a response message to the scale-in request (step S3). Note that the transmission of the response message to this scale-in request is not limited to this order of steps, and may be, for example, after step S6.

Subsequently, the scaling processing unit 13 of the virtual resource management device 1 (virtual network control unit 10) transmits a scale-in preparation request, including the virtual ID of the virtual resource to be deleted identified by the virtual resource identification unit 12, to a corresponding VNF 8 (step S4).

In response to this, the VNF 8 perform scale-in preparation including processing of stopping the communication to the virtual resource to be deleted among the communications transmitted from the client terminal 3 and other VNFs 8, which are processed by the VNF 8.

In response to receiving from the VNF 8 a message indicating the scale-in preparation has been completed (step S5), the scaling processing unit 13 deletes the virtual resource to be deleted (step S6).

As described above, the virtual resource management device 1 according to the present embodiment makes it possible to identify and release the virtual resource to be deleted according to the deletion strategy specified in the scale-in request.

### Modifications

Note that, in the present embodiment, a case has been described in which the feature configuration in the present application is incorporated into the NFV MANO defined in the ETSI NFV standards specifications (NPL 1), as illustrated in FIG. 1. However, the feature configuration in the present application may be of a separate device whose functions are separate from the functions of the NFV MANO, so as to be incorporated into the network virtualization system.

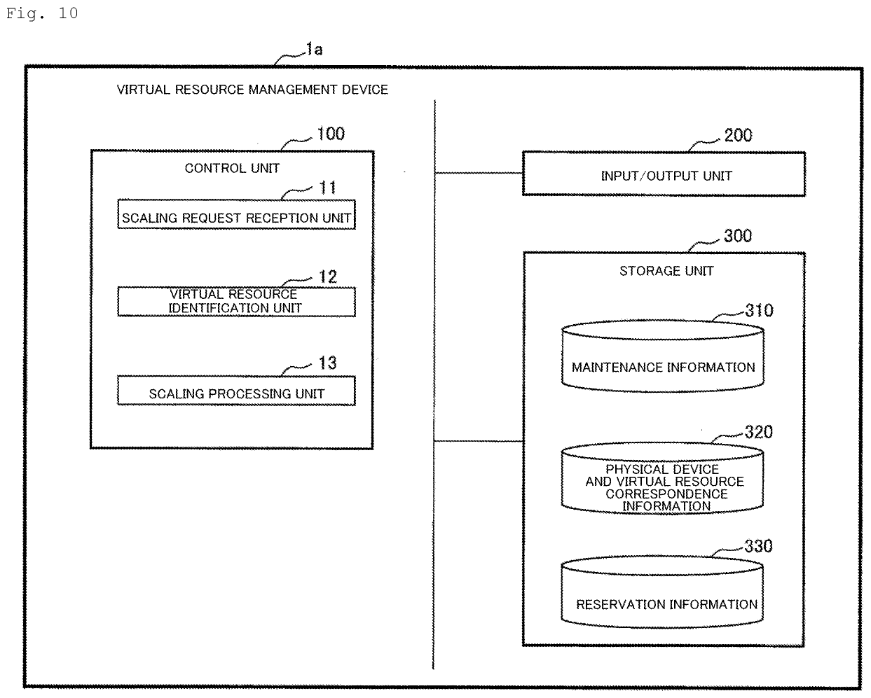

FIG. 10 is a functional block diagram illustrating the configuration of a virtual resource management device 1a according to a modification of the present embodiment.

This virtual resource management device 1a is a device that executes processing (scale-in) of identifying and deleting (releasing) virtual resources that make up a VNF, and includes a control unit 100, an input/output unit 200, and a storage unit 300, as illustrated in FIG. 10.

The input/output unit 200 receives an input of information from and outputs information to each VNF, the physical device 5, other external devices having the functions of the VNF MANO, and the like.

The storage unit 300 stores maintenance information 310, physical device and virtual resource correspondence information 320, and reservation information 330.

The control unit 100 includes the scaling request reception unit 11, the virtual resource identification unit 12, and the scaling processing unit 13, which are the functions of the virtual network control unit 10 illustrated in FIG. 1. Then, the scaling request reception unit 11, the virtual resource identification unit 12, and the scaling processing unit 13 cooperate with an external device having the functions of the VNF MANO in the network virtualization system 1000 to execute their processing.

Even with such a configuration, it is possible to identify and release a virtual resource when scale-in is performed that is processing of reducing the amount of virtual resources that make up a VNF.

### Hardware Configuration

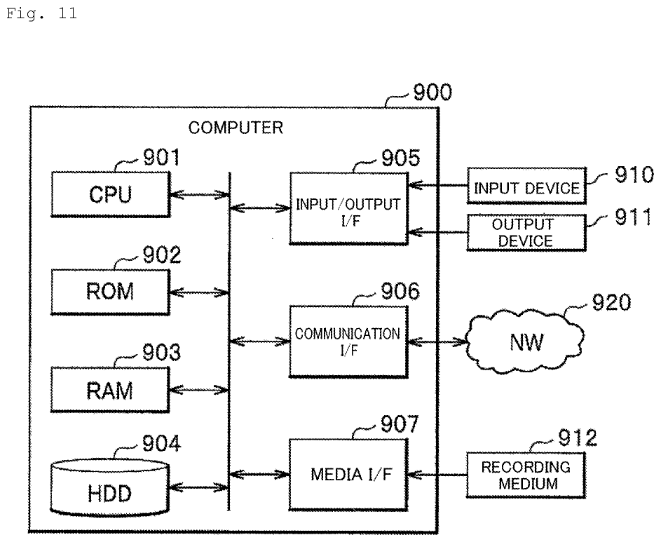

The virtual resource management device 1 (1a) according to the present embodiment is realized by, for example, a computer 900 having a configuration as illustrated in FIG. 11.

FIG. 11 is a hardware configuration diagram illustrating an example of the computer 900 that implements the functions of the virtual resource management device 1 (1a) according to the present embodiment. The computer 900 includes a CPU 901, a ROM (Read Only Memory) 902, a RAM 903, an HDD (Hard Disk Drive) 904, an input/output I/F (Interface) 905, a communication I/F 906, and a media I/F 907.

The CPU 901 operates based on a program stored in the ROM 902 or the HDD 904, and implements the control units controlling in the virtual resource management device 1 illustrated in FIG. 1 and the virtual resource management device 1a illustrated in FIG. 10. The ROM 902 stores a boot program executed by the CPU 901 when the computer 900 is started, a program related to the hardware of the computer 900, and the like.

The CPU 901 controls an input device 910 such as a mouse and a keyboard and an output device 911 such as a display, via the input/output I/F 905. The CPU 901 acquires data from the input device 910 and outputs generated data to the output device 911, via the input/output I/F 905. Note that a GPU (Graphics Processing Unit) or the like may be used together with the CPU 901 as processors.

The HDD 904 stores a program executed by the CPU 901, data used by the program, and the like. The communication I/F 906 receives data from another device via a communication network (e.g., a NW (network) 920) and outputs the data to the CPU 901, and transmits the data generated by the CPU 901 to the other device via the communication network.

The media I/F 907 reads a program or data stored in a recording medium 912 and outputs the program or data to the CPU 901 via the RAM 903. The CPU 901 loads a program related to the target processing from the recording medium 912 onto the RAM 903 via the media I/F 907, and executes the loaded program. The recording medium 912 is an optical recording medium such as a DVD (Digital Versatile Disc) or PD (Phase change rewritable Disk), a magneto-optical recording medium such as MO (Magneto Optical disk), a magnetic recording medium, a conductor memory tape medium, a semiconductor memory, or the like.

For example, in a case where the computer 900 functions as the virtual resource management device 1 (1a) according to the present embodiment, the CPU 901 of the computer 900 executes the program loaded onto the RAM 903 to implement the functions of the virtual resource management device 1 (1a). Further, the data in the RAM 903 is stored in the HDD 904. The CPU 901 reads a program related to the target processing from the recording medium 912 and executes the program. In addition, the CPU 901 may read a program related to the target processing from another device via the communication network (NW 920).

### Effects

The effects of the virtual resource management device and the others according to the present invention will be described below.

A virtual resource management device according to the present invention executes scale-in of virtual resources that make up a VNF. The virtual resource management device 1 (1a) includes a scaling request reception unit 11 that receives a scale-in request that is a scaling request to request scale-in; a virtual resource identification unit 12 that identifies a virtual resource to be deleted by using a predetermined virtual resource identification logic according to a deletion strategy indicated by the scale-in request; and a scaling processing unit 13 that transmits a scale-in preparation request including information on the identified virtual resource to the VNF to which the virtual resource to be deleted is assigned to stop communication to the virtual resource to be deleted, and in response to receiving a scale-in preparation completion response indicating the communication has been stopped from the VNF, deletes the virtual resource to be deleted.

With such a configuration, the virtual resource management device 1 (1a) according to the present invention makes it possible to identify and release the virtual resource to be deleted according to the deletion strategy specified in the scale-in request.

Further, in the virtual resource management device 1 (1a), for a deletion strategy for deletion target specification, the predetermined virtual resource identification logic identifies the virtual resource to be deleted based on a virtual resource ID specified by a parameter indicated by the scale-in request, and when the virtual resource identification unit 12 confirms that the deletion strategy indicated by the scale-in request is for deletion target specification, the virtual resource identification unit 12 identifies the virtual resource indicated by the virtual resource ID specified by the parameter as the virtual resource to be deleted.

In this way, for the deletion strategy for deletion target specification, the virtual resource management device 1 (1a) can identify and delete the virtual resource to be deleted based on the virtual resource ID indicated by the scaling request.

Further, in the virtual resource management device 1 (1a), for a deletion strategy for maintenance save, the predetermined virtual resource identification logic extracts a maintenance ID specified by a parameter indicated by the scale-in request, identifies a physical device 5 to be maintained based on the extracted maintenance ID, and identifies a virtual resource being operated on the identified physical device 5, and when the virtual resource identification unit 12 confirms that the deletion strategy indicated by the scale-in request is for maintenance save, the virtual resource identification unit 12 extracts the maintenance ID specified by the parameter, refers to maintenance information in which the maintenance ID and the physical device 5 to be maintained are associated with each other based on the extracted maintenance ID to identify the physical device 5 to be maintained, and refers to physical device and virtual resource correspondence information in which the physical device 5 and the virtual resource being operated on the physical device 5 are associated with each other by using information on the identified physical device 5 to identify the virtual resource being operated on the identified physical device 5.

In this way, for the deletion strategy for maintenance save, the virtual resource management device 1 (1a) can extract the maintenance ID indicated by the scaling request, identify the physical device 5 to be maintained based on the extracted maintenance ID, and identify and delete the virtual resource being operated on the physical device 5.

Further, in the virtual resource management device 1 (1a), for a deletion strategy for reserved resource release, the predetermined virtual resource identification logic extracts a reservation ID specified by a parameter indicated by the scale-in request, and identifies a virtual resource being operated corresponding to a reserved resource based on the extracted reservation ID, and when the virtual resource identification unit 12 confirms that the deletion strategy indicated by the scale-in request is for reserved resource release, the virtual resource identification unit 12 extracts the reservation ID specified by the parameter, and refers to reservation information in which the reservation ID and the virtual resource being operated corresponding to the reserved resource are associated with each other by using the extracted reservation ID to identify the virtual resource being operated corresponding to the reserved resource.

In this way, for the deletion strategy for reserved resource release, the virtual resource management device 1 (1a) can extract the reservation ID indicated by the scaling request, and identify and delete the virtual resource being operated corresponding to the reserved resource based on the extracted reservation ID.

Note that the present invention is not limited to the embodiment described above, and various modifications can be made by a person of ordinary skill in the art within the technical idea of the present invention.

For example, the virtual resource management device 1 (1a) according to the present embodiment has been described that has functions (feature configuration) that possible deletion strategies received as a scale-in request are for all the three of “deletion target specification”, “maintenance save”, and “reserved resource release”. However, the device is not limited to such an embodiment, and may be for only one of the three deletion strategies or a combination of any of the three deletion strategies. Further, it may be configured to set other additional deletion strategies to function.

### REFERENCE SIGNS LIST

1, 1a Virtual resource management device

3 Client terminal

5 Physical device

6 Virtual resource

7 Virtual infrastructure

8 VNF

10 Virtual network control unit

11 Scaling request reception unit

12 Virtual resource identification unit

13 Scaling processing unit

20 Virtualization orchestrator unit

21 Maintenance information management unit

22 Physical device and virtual resource correspondence information management unit

23 Reservation information management unit

30 Virtual infrastructure management unit

31 Physical device control unit

100 Control unit

200 Input/output unit

300 Storage unit

310 Maintenance information

320 Physical device and virtual resource correspondence information

330 Reservation information

1000 Network virtualization system

1. A virtual resource management device that executes scale-in of virtual resources that make up a VNF (Virtual Network Function), the virtual resource management device comprising:
a scaling request reception unit, including one or more processors, configured to receive a scale-in request that is a scaling request to request scale-in;
a virtual resource identification unit, including one or more processors, configured to identify a virtual resource to be deleted by using a predetermined virtual resource identification logic according to a deletion strategy indicated by the scale-in request; and
a scaling processing unit, including one or more processors, configured to transmit a scale-in preparation request including information on the identified virtual resource to the VNF to which the virtual resource to be deleted is assigned to stop communication to the virtual resource to be deleted, and in response to receiving a scale-in preparation completion response indicating the communication has been stopped from the VNF, deletes the virtual resource to be deleted.

2. The virtual resource management device according to claim 1, wherein
for a deletion strategy for deletion target specification, the predetermined virtual resource identification logic identifies the virtual resource to be deleted based on a virtual resource ID specified by a parameter indicated by the scale-in request, and
when the virtual resource identification unit confirms that the deletion strategy indicated by the scale-in request is for deletion target specification, the virtual resource identification unit is configured to identify the virtual resource indicated by the virtual resource ID specified by the parameter as the virtual resource to be deleted.

3. The virtual resource management device according to claim 1, wherein
for a deletion strategy for maintenance save, the predetermined virtual resource identification logic extracts a maintenance ID specified by a parameter indicated by the scale-in request, identifies a physical device to be maintained based on the extracted maintenance ID, and identifies a virtual resource being operated on the identified physical device, and
when the virtual resource identification unit confirms that the deletion strategy indicated by the scale-in request is for maintenance save, the virtual resource identification unit is configured to extract the maintenance ID specified by the parameter,
refer to maintenance information in which the maintenance ID and the physical device to be maintained are associated with each other based on the extracted maintenance ID to identify the physical device to be maintained, and
refer to physical device and virtual resource correspondence information in which the physical device and the virtual resource being operated on the physical device are associated with each other by using information on the identified physical device to identify the virtual resource being operated on the identified physical device.

4. The virtual resource management device according to claim 1, wherein
for a deletion strategy for reserved resource release, the predetermined virtual resource identification logic extracts a reservation ID specified by a parameter indicated by the scale-in request, and identifies a virtual resource being operated corresponding to a reserved resource based on the extracted reservation ID, and
when the virtual resource identification unit confirms that the deletion strategy indicated by the scale-in request is for reserved resource release, the virtual resource identification unit is configured to extract the reservation ID specified by the parameter, and
refer to reservation information in which the reservation ID and the virtual resource being operated corresponding to the reserved resource are associated with each other by using the extracted reservation ID to identify the virtual resource being operated corresponding to the reserved resource.

5. A virtual resource management method performed by a virtual resource management device that executes scale-in of virtual resources that make up a VNF, the virtual resource management method comprising:
by the virtual resource management device,
receiving a scale-in request that is a scaling request to request scale-in;
identifying a virtual resource to be deleted by using a predetermined virtual resource identification logic according to a deletion strategy indicated by the scale-in request; and
transmitting a scale-in preparation request including information on the identified virtual resource to the VNF to which the virtual resource to be deleted is assigned to stop communication to the virtual resource to be deleted, and in response to receiving a scale-in preparation completion response indicating the communication has been stopped from the VNF, deleting the virtual resource to be deleted.

6. A non-transitory computer readable medium storing one or more instructions causing a computer to function as a virtual resource management device that executes scale-in of virtual resources that make up a VNF (Virtual Network Function), the one or more instructions causing the computer to execute:
receiving a scale-in request that is a scaling request to request scale-in;
identifying a virtual resource to be deleted by using a predetermined virtual resource identification logic according to a deletion strategy indicated by the scale-in request and
transmitting a scale-in preparation request including information on the identified virtual resource to the VNF to which the virtual resource to be deleted is assigned to stop communication to the virtual resource to be deleted, and in response to receiving a scale-in preparation completion response indicating the communication has been stopped from the VNF, deleting the virtual resource to be deleted.

7. The virtual resource management method according to claim 5, wherein for a deletion strategy for deletion target specification, the predetermined virtual resource identification logic identifies the virtual resource to be deleted based on a virtual resource ID specified by a parameter indicated by the scale-in request, and
the method comprises:
when confirming that the deletion strategy indicated by the scale-in request is for deletion target specification, identifying the virtual resource indicated by the virtual resource ID specified by the parameter as the virtual resource to be deleted.

8. The virtual resource management method according to claim 5, wherein
for a deletion strategy for maintenance save, the predetermined virtual resource identification logic extracts a maintenance ID specified by a parameter indicated by the scale-in request, identifies a physical device to be maintained based on the extracted maintenance ID, and identifies a virtual resource being operated on the identified physical device, and
the method comprises:
when confirming that the deletion strategy indicated by the scale-in request is for maintenance save, extracting the maintenance ID specified by the parameter,
referring to maintenance information in which the maintenance ID and the physical device to be maintained are associated with each other based on the extracted maintenance ID to identify the physical device to be maintained, and
referring to physical device and virtual resource correspondence information in which the physical device and the virtual resource being operated on the physical device are associated with each other by using information on the identified physical device to identify the virtual resource being operated on the identified physical device.

9. The virtual resource management method according to claim 5, wherein
for a deletion strategy for reserved resource release, the predetermined virtual resource identification logic extracts a reservation ID specified by a parameter indicated by the scale-in request, and identifies a virtual resource being operated corresponding to a reserved resource based on the extracted reservation ID, and
the method comprises:
when confirming that the deletion strategy indicated by the scale-in request is for reserved resource release, extracting the reservation ID specified by the parameter, and
referring to reservation information in which the reservation ID and the virtual resource being operated corresponding to the reserved resource are associated with each other by using the extracted reservation ID to identify the virtual resource being operated corresponding to the reserved resource.

10. The non-transitory computer readable medium according to claim 6, wherein
for a deletion strategy for deletion target specification, the predetermined virtual resource identification logic identifies the virtual resource to be deleted based on a virtual resource ID specified by a parameter indicated by the scale-in request, and
the one or more instructions cause the computer to execute:
when confirming that the deletion strategy indicated by the scale-in request is for deletion target specification, identifying the virtual resource indicated by the virtual resource ID specified by the parameter as the virtual resource to be deleted.

11. The non-transitory computer readable medium according to claim 6, wherein
for a deletion strategy for maintenance save, the predetermined virtual resource identification logic extracts a maintenance ID specified by a parameter indicated by the scale-in request, identifies a physical device to be maintained based on the extracted maintenance ID, and identifies a virtual resource being operated on the identified physical device, and
the one or more instructions cause the computer to execute:
when confirming that the deletion strategy indicated by the scale-in request is for maintenance save, extracting the maintenance ID specified by the parameter,
referring to maintenance information in which the maintenance ID and the physical device to be maintained are associated with each other based on the extracted maintenance ID to identify the physical device to be maintained, and
referring to physical device and virtual resource correspondence information in which the physical device and the virtual resource being operated on the physical device are associated with each other by using information on the identified physical device to identify the virtual resource being operated on the identified physical device.

12. The non-transitory computer readable medium according to claim 6, wherein
for a deletion strategy for reserved resource release, the predetermined virtual resource identification logic extracts a reservation ID specified by a parameter indicated by the scale-in request, and identifies a virtual resource being operated corresponding to a reserved resource based on the extracted reservation ID, and
the one or more instructions cause the computer to execute:
when confirming that the deletion strategy indicated by the scale-in request is for reserved resource release, extracting the reservation ID specified by the parameter, and
referring to reservation information in which the reservation ID and the virtual resource being operated corresponding to the reserved resource are associated with each other by using the extracted reservation ID to identify the virtual resource being operated corresponding to the reserved resource.
